(19) United States
(12) Patent Application Publication
(10) Pub. No.: US 2026/0285298 A1
(43) Pub. Date: Sep. 24, 2026

(54) VEHICLE CONTROL SYSTEM

(71) Applicant: HONDA MOTOR CO., LTD., Tokyo (JP)

(72) Inventors: Nobuharu NAGAOKA, Tokyo (JP); Shun MORISHITA, Tokyo (JP); Hiromu AOKI, Tokyo (JP)

(21) Appl. No.: 19/545,682

(22) Filed: Feb. 20, 2026

(30) Foreign Application Priority Data
Mar. 18, 2025 (JP) 2025-043088

(51) Int. Cl. B60W 30/06

(52) U.S. Cl. CPC B60W 30/06; B60W 2554/20

(57) ABSTRACT

A vehicle control system includes an acquirer configured to acquire information about a surrounding area of a vehicle, and a parking controller configured to execute parking control of the vehicle based on an acquisition result of the acquirer. The parking controller is configured to execute a first determination process including determination as to whether parking in a prescribed area within the surrounding area is prohibited or restricted, determine whether to start or continue the parking control based on a result of the first determination process, and execute, upon determining to start or continue the parking control, a second determination process at a position closer to a target parking position within the prescribed area than a position at which the first determination process is executed. The second determination process includes determination as to whether parking at the target parking position is prohibited or restricted.

### TECHNICAL FIELD

The present invention relates to a vehicle control system.

### BACKGROUND ART

In recent years, there has been an increase in efforts to provide sustainable transport systems that take into consideration vulnerable people among transport participants. To achieve this, research and development into an autonomous driving technology and a driving assistance technology is being conducted to further improve traffic safety and convenience.

Research and development into parking control is being conducted as a part of research and development into an autonomous driving technology and a driving assistance technology. For example, U.S. Pat. No. 11,756,424 discloses a technology for detecting a parking indicator (such as a curb) that indicates a parking area in parking control.

In parking control, it may be turned out that parking at a target parking position is prohibited or that unexpected restrictions are imposed on the target parking position after a vehicle approaches the target parking position. In such a case, the parking control is suspended after the vehicle approaches the target parking position, which places a heavy burden on an occupant.

### SUMMARY OF THE INVENTION

In view of the above background, an object of the present invention is to provide a vehicle control system that can reduce the burden on an occupant by determining whether to start or continue parking control at an earlier stage. Further, another object of the present invention is to contribute to the development of sustainable transport systems.

To achieve such an object, one aspect of the present invention provides a vehicle control system comprising: an acquirer configured to acquire information about a surrounding area of a vehicle; and a parking controller configured to execute parking control of the vehicle based on an acquisition result of the acquirer, wherein the parking controller is configured to: execute a first determination process including determination as to whether parking in a prescribed area within the surrounding area is prohibited or restricted; determine whether to start or continue the parking control based on a result of the first determination process; and execute, upon determining to start or continue the parking control, a second determination process at a position closer to a target parking position within the prescribed area than a position at which the first determination process is executed, the second determination process including determination as to whether parking at the target parking position is prohibited or restricted.

Thus, according to the above aspects, it is possible to provide a vehicle control system that can reduce the burden on an occupant by determining whether to start or continue parking control at an earlier stage.

### BRIEF DESCRIPTION OF THE DRAWING(S)

FIG. 1 is a block diagram showing a vehicle to which a vehicle control system according to an embodiment is applied;

FIGS. 2A and 2B are plan views each illustrating a surrounding area of the vehicle according to the embodiment;

FIG. 3 is a flowchart showing an example 1 of vehicle control according to the embodiment;

FIGS. 4A to 4E are plan views showing the example 1 of the vehicle control according to the embodiment;

FIG. 5 is a flowchart showing an example 2 of the vehicle control according to the embodiment; and

FIGS. 6A to 6E are plan views showing a parking trajectory for another modified embodiment.

### DETAILED DESCRIPTION OF THE INVENTION

In the following, an embodiment of a vehicle control system 1 will be described with reference to the drawings.

### The Vehicle 3

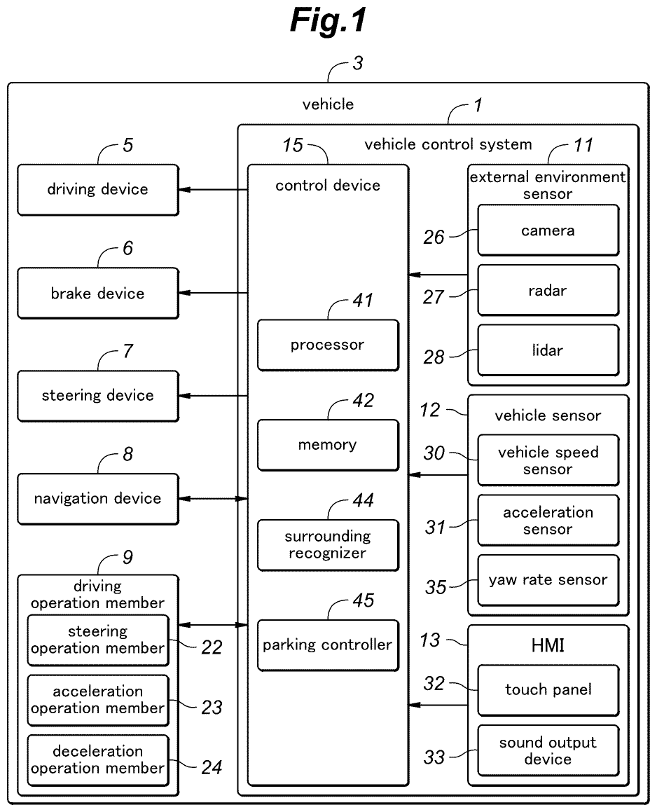

FIG. 1 is a block diagram showing a vehicle 3 to which the vehicle control system 1 is applied. For example, the vehicle 3 is an automobile. In another embodiment, the vehicle 3 may be a vehicle other than an automobile (for example, a motorcycle).

The vehicle 3 includes a driving device 5, a brake device 6, a steering device 7, a navigation device 8, a driving operation member 9, an external environment sensor 11, a vehicle sensor 12, an HMI 13 (Human Machine Interface), and a control device 15. The external environment sensor 11 is an example of an acquirer. The HMI 13 is an example of a notifier and an operation unit. In the present embodiment, the external environment sensor 11, the vehicle sensor 12, the HMI 13, and the control device 15 constitute the vehicle control system 1.

The driving device 5 is a device that applies a driving force to the vehicle 3. The driving device 5 includes a driving source that generates the driving force for causing the vehicle 3 to travel. For example, the driving source may be composed of an internal combustion engine and/or an electric motor.

The brake device 6 is a device that applies a braking force to the vehicle 3. For example, the brake device 6 includes a brake caliper that presses a pad against a brake rotor, and an electric cylinder that supplies hydraulic pressure to the brake caliper.

The steering device 7 is a device that changes the steering angle of wheels by turning the wheels. For example, the steering device 7 includes a rack and pinion mechanism connected to the wheels, and an electric motor that drives the rack and pinion mechanism.

The navigation device 8 is a device that provides route guidance to the destination of the vehicle 3. The navigation device 8 stores map information. The navigation device 8 determines the current position of the vehicle 3 based on GNSS signals (for example, GPS signals) received from artificial satellites.

The driving operation member 9 is a device that receives driving operations by an occupant of the vehicle 3 (hereinafter simply referred to as “the occupant”). The driving operation member 9 includes a steering operation member 22 (for example, a steering wheel) that receives a steering operation of the vehicle 3 by the occupant, an acceleration operation member 23 (for example, an accelerator pedal) that receives an acceleration operation of the vehicle 3 by the occupant, and a deceleration operation member 24 (for example, a brake pedal) that receives a deceleration operation of the vehicle 3 by the occupant.

The external environment sensor 11 is a device that acquires information about a surrounding area A1 (details of which will be described later) of the vehicle 3. The external environment sensor 11 includes a plurality of cameras 26, a plurality of radars 27, and a plurality of lidars 28 (LiDAR). Each camera 26 captures images of objects (surrounding vehicles, pedestrians, road structures, lane markings, and the like) present in the surrounding area A1 of the vehicle 3. Each radar 27 emits radio waves such as millimeter waves toward the surrounding area A1 of the vehicle 3 and receives the reflection waves thereof to detect the positions of the objects present in the surrounding area A1 of the vehicle 3. Each lidar 28 emits light such as infrared light toward the surrounding area A1 of the vehicle 3 and receives the reflection light thereof to detect the positions of the objects present in the surrounding area A1 of the vehicle 3.

The vehicle sensor 12 is a sensor that detects the traveling state of the vehicle 3. The vehicle sensor 12 includes a vehicle speed sensor 30 that detects the vehicle speed of the vehicle 3, an acceleration sensor 31 that detects the acceleration and deceleration of the vehicle 3, and a yaw rate sensor 35 that detects the angular velocity of the vehicle 3 around the vertical axis.

The HMI 13 is a device that executes a notification to the occupant and receives operations by the occupant. The HMI 13 includes a touch panel 32 and a sound output device 33. The touch panel 32 displays various screens to the occupant and also receives input operations by the occupant on the various screens. The sound output device 33 outputs audio guidance, warning sounds, and the like.

### The Control Device 15

The control device 15 is a computer including a processor 41 and a memory 42 communicatively connected to the processor 41. The processor 41 may include, for example, at least one of a CPU, a GPU, or an MPU as a core. The memory 42 stores programs executed by the processor 41 and various data. The memory 42 may include at least one of volatile memory or non-volatile memory. The volatile memory may be, for example, a DRAM or an SRAM. The non-volatile memory may be an SSD, a flash memory, a magnetic disk storage device, or an optical disk storage device. At least a portion of the control device 15 may be realized by hardware such as an LSI, an ASIC, or an FPGA, or may be realized by a combination of software and hardware. The control device 15 may be composed of a single piece of hardware, or may be composed of plural pieces of hardware that can communicate with each other.

The control device 15 includes a surrounding recognizer 44 and a parking controller 45 as functional units. The processor 41 executes the programs stored in the memory 42 to function as the surrounding recognizer 44 and the parking controller 45.

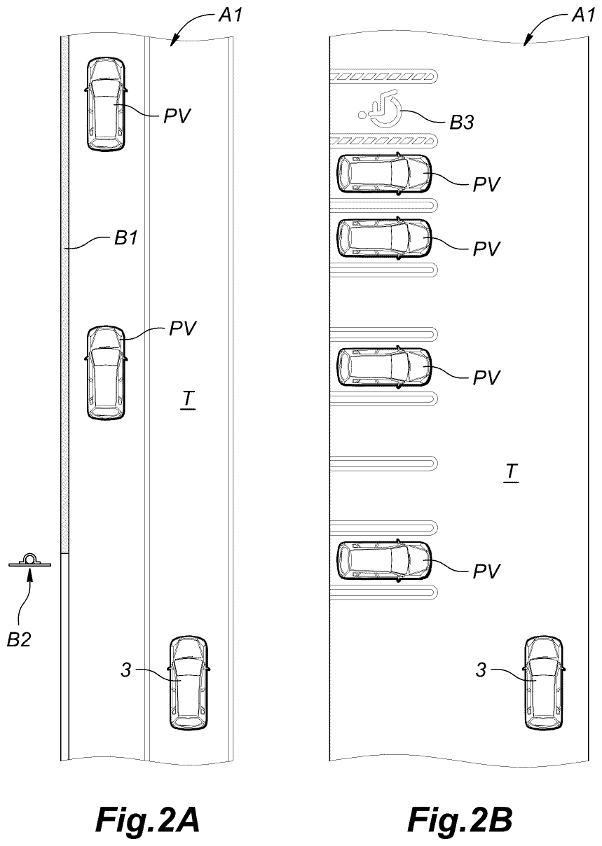

With reference to FIG. 2, the surrounding recognizer 44 recognizes the situation of the surrounding area A1 of the vehicle 3 based on the acquisition result of the external environment sensor 11. For example, the surrounding recognizer 44 recognizes the road structures present in the surrounding area A1 (for example, the road structures present on the side of a traveling path T on which the vehicle 3 is traveling) based on the acquisition result of the external environment sensor 11. The road structures recognized by the surrounding recognizer 44 include a curb B1, a road sign B2, a road marking B3, and the like. The surrounding recognizer 44 recognizes a parked vehicle PV present in the surrounding area A1 (for example, the parked vehicle present on the side of the traveling path T on which the vehicle 3 is traveling) based on the acquisition result of the external environment sensor 11.

With reference to FIG. 1, the parking controller 45 executes parking control of the vehicle 3 based on the recognition result of the surrounding recognizer 44. In other words, the parking controller 45 executes the parking control of the vehicle 3 based on the acquisition result of the external environment sensor 11. The parking control executed by the parking controller 45 includes automatic parking control in which the parking controller 45 automatically executes a parking process from start to finish, and parking assistance control in which the parking controller 45 assists the driver in their driving operation during the parking process.

### The Example 1 of the Vehicle Control

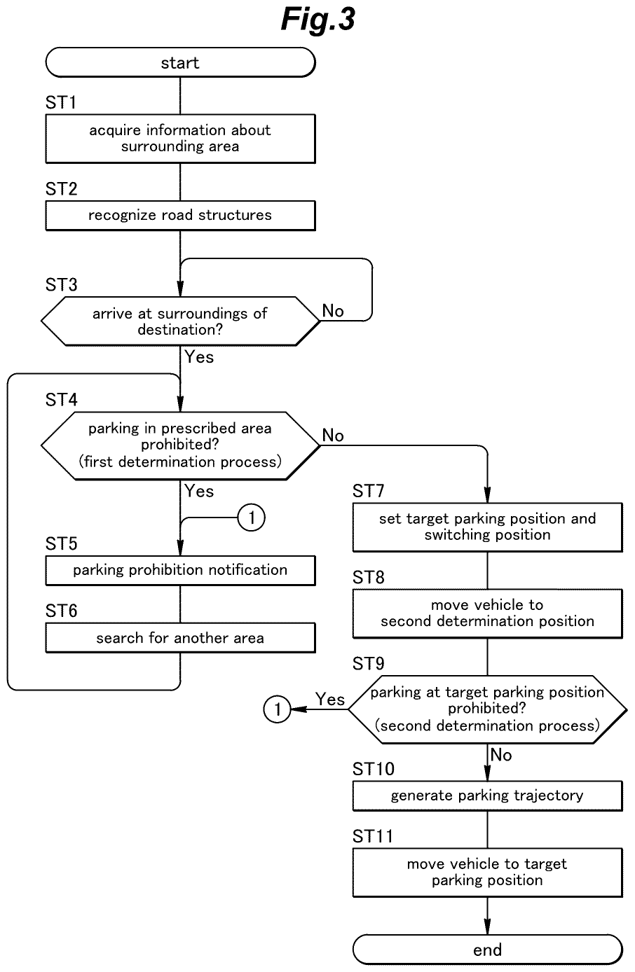

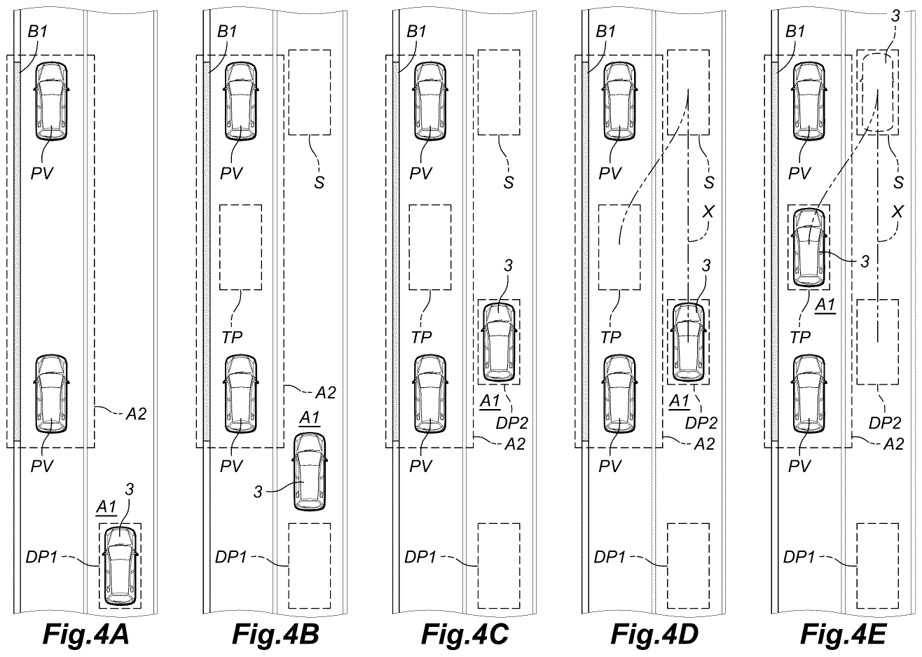

Next, with reference to FIGS. 3 and 4A to 4E, the example 1 of the vehicle control including the parking control will be described. The example 1 of the vehicle control is an example for parking the vehicle 3 at a target parking position TP by the parking control (particularly, the automatic parking control).

When the main power supply of the vehicle 3 is turned on, the external environment sensor 11 acquires information about the surrounding area A1 of the vehicle 3 (step ST1). Next, the surrounding recognizer 44 recognizes the road structures (the curb B1, the road sign B2, the road marking B3, and the like) present in the surrounding area A1 based on the acquisition result of the external environment sensor 11 (step ST2).

Next, the parking controller 45 determines whether the vehicle 3 has arrived at the surroundings of the destination based on the recognition result of the surrounding recognizer 44 and the map information (step ST3). In a case where the vehicle 3 has not arrived at the surroundings of the destination (step ST3: No), the parking controller 45 repeats the determination in step ST3 until the vehicle 3 arrives at the surroundings of the destination.

In a case where the vehicle 3 has arrived at the surroundings of the destination (step ST3: Yes), the parking controller 45 executes a first determination process at a first determination position DP1 (step ST4). With reference to FIG. 4A, in the first determination process, the parking controller 45 determines whether parking in a prescribed area A2 is prohibited based on the road structures present in the prescribed area A2 within the surrounding area A1 (the size of the surrounding area A1 is larger than the size of the prescribed area A2). For example, in a case where the curb B1 of the prescribed color (for example, a red curb) is present in the prescribed area A2, the parking controller 45 determines that parking in the prescribed area A2 is prohibited. On the other hand, in a case where the curb B1 of the prescribed color is not present in the prescribed area A2, the parking controller 45 determines that parking in the prescribed area A2 is not prohibited. Further, when the parked vehicle PV is already present in the prescribed area A2, the parking controller 45 may determine that parking in the prescribed area A2 is not prohibited (parking in the prescribed area A2 is possible).

In a case where the parking controller 45 determines that parking in the prescribed area A2 is prohibited (step ST4: Yes), that is, in a case where the determination result of the first determination process is Yes, the parking controller 45 does not start the automatic parking control. In this case, the parking controller 45 causes the HMI 13 to execute a parking prohibition notification (step ST5). The parking prohibition notification is a notification indicating that parking in the prescribed area A2 is prohibited. For example, the parking prohibition notification includes a message such as “Parking is prohibited in this location.”

Next, the parking controller 45 searches for another area within the surrounding area A1 (step ST6) and executes the first determination process again with that area being set as the prescribed area A2 (step ST4). The parking controller 45 repeats the processes of steps ST4 to ST6 until the determination result in step ST4 becomes No.

In a case where the parking controller 45 determines that parking in the prescribed area A2 is not prohibited (step ST4: No), that is, in a case where the determination result of the first determination process is No, the parking controller 45 starts the automatic parking control. In this case, with reference to FIG. 4B, the parking controller 45 sets the target parking position TP within the prescribed area A2 (the size of the prescribed area A2 is larger than the size of the target parking position TP), and also sets a switching position S of the vehicle 3 in the vicinity of the target parking position TP (step ST7). The size of the target parking position TP is large enough to accommodate the vehicle 3.

With reference to FIG. 4C, next, the parking controller 45 moves the vehicle 3 to a second determination position DP2 between the first determination position DP1 and the switching position S (step ST8). The second determination position DP2 is closer to the target parking position TP than the first determination position DP1 is. In other words, the linear distance from the second determination position DP2 to the target parking position TP is shorter than the linear distance from the first determination position DP1 to the target parking position TP. The second determination position DP2 is a position in the vicinity of the target parking position TP, and is a position where an on-board sensor (for example, the external environment sensor 11) can acquire the situation of the target parking position TP.

Next, the parking controller 45 executes a second determination process at the second determination position DP2 (step ST9). That is, the parking controller 45 executes the second determination process before the vehicle 3 reaches the switching position S. In the second determination process, the parking controller 45 determines whether parking at the target parking position TP is prohibited based on the road structures present in the prescribed area A2. For example, in a case where the curb B1 of the prescribed color (for example, a red curb) is present on the side of the target parking position TP within the prescribed area A2, the parking controller 45 determines that parking at the target parking position TP is prohibited. On the other hand, in a case where the curb B1 of the prescribed color is not present on the side of the target parking position TP within the prescribed area A2, the parking controller 45 determines that parking at the target parking position TP is not prohibited.

In a case where the parking controller 45 determines that parking at the target parking position TP is prohibited (step ST9: Yes), that is, in a case where the determination result of the second determination process is Yes, the parking controller 45 does not continue the automatic parking control. In this case, the parking controller 45 suspends the automatic parking control before the vehicle 3 reaches the switching position S, and causes the HMI 13 to execute the parking prohibition notification (step ST5).

In a case where the parking controller 45 determines that parking at the target parking position TP is not prohibited (step ST9: No), that is, in a case where the determination result of the second determination process is No, the parking controller 45 continues the automatic parking control. In this case, with reference to FIG. 4D, the parking controller 45 generates a parking trajectory X that leads from the second determination position DP2 to the target parking position TP via the switching position S (step ST10).

Next, with reference to FIG. 4E, the parking controller 45 moves the vehicle 3 along the parking trajectory X from the second determination position DP2 to the target parking position TP (step ST11). For example, the parking controller 45 moves the vehicle 3 forward from the second determination position DP2 to the switching position S, switches the vehicle 3 at the switching position S, and then moves the vehicle 3 rearward from the switching position S to the target parking position TP. This completes the automatic parking control.

### The Example 2 of the Vehicle Control

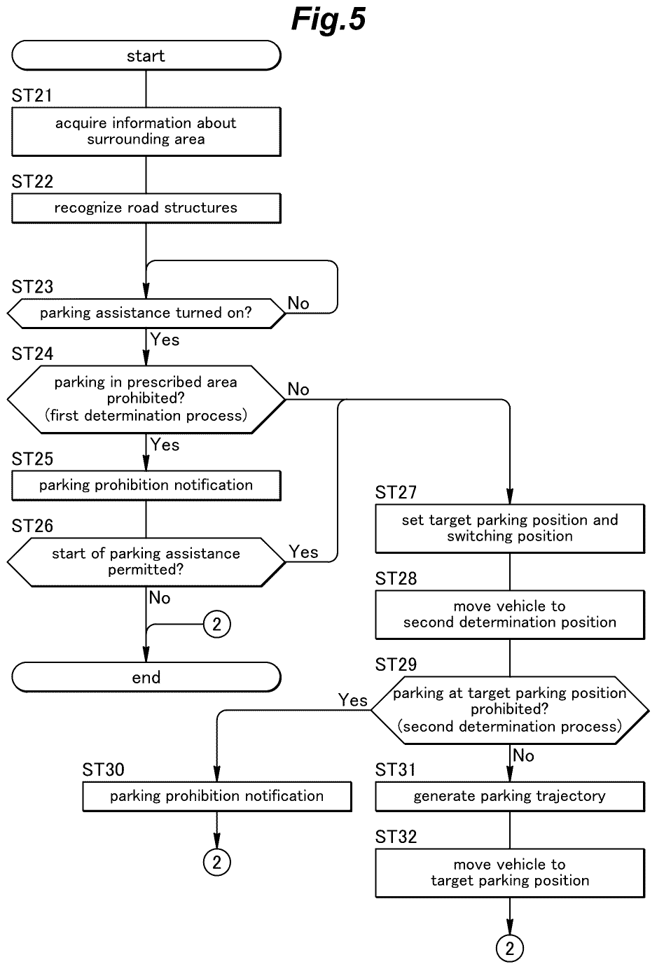

Next, with reference to FIG. 5, the example 2 of the vehicle control including the parking control will be described. The example 2 of the vehicle control is an example for assisting the driving operation of the driver by the parking control (particularly, the parking assistance control). The contents of steps ST21 to ST22 of the example 2 of the vehicle control are the same as the contents of steps ST1 to ST2 of the example 1 of the vehicle control, and therefore the description thereof will be omitted.

When step ST22 is completed, the parking controller 45 determines whether the occupant has turned on the parking assistance (step ST23). For example, in a case where the HMI 13 has received a turning-on operation of the parking assistance by the occupant, the parking controller 45 determines that the occupant has turned on the parking assistance. On the other hand, in a case where the HMI 13 has not received the turning-on operation of the parking assistance by the occupant, the parking controller 45 determines that the occupant has not turned on the parking assistance. In a case where the occupant has not turned on the parking assistance (step ST23: No), the parking controller 45 repeats the determination in step ST23 until the occupant turns on the parking assistance.

In a case where the occupant has turned on the parking assistance (step ST23: Yes), the parking controller 45 executes the first determination process at the first determination position DP1 (step ST24). The contents of the first determination process are the same as those of the example 1 of the vehicle control, and therefore the description thereof will be omitted.

In a case where the parking controller 45 determines that parking in the prescribed area A2 is prohibited (step ST24: Yes), that is, in a case where the determination result of the first determination process is Yes, the parking controller 45 causes the HMI 13 to execute the parking prohibition notification (step ST25). The contents of the parking prohibition notification are the same as those of the example 1 of the vehicle control, and therefore the description thereof will be omitted.

Next, the parking controller 45 determines whether the occupant has permitted the start of the parking assistance (step ST26). For example, in a case where the HMI 13 has received a permission operation for the parking assistance by the occupant, the parking controller 45 determines that the occupant has permitted the start of the parking assistance. On the other hand, in a case where the HMI 13 has not received the permission operation for the parking assistance by the occupant, the parking controller 45 determines that the occupant has not permitted the start of the parking assistance.

In a case where the occupant has not permitted the start of the parking assistance (step ST26: No), the parking controller 45 does not start the parking assistance control. In this case, the parking controller 45 terminates the vehicle control without executing the parking assistance control.

In a case where the parking controller 45 determines that parking in the prescribed area A2 is not prohibited (step ST24: No), that is, in a case where the determination result of the first determination process is No, or in a case where the parking controller 45 determines that the occupant has permitted the start of the parking assistance (step ST26: Yes), the parking controller 45 starts the parking assistance control. In this case, the parking controller 45 sets the target parking position TP within the prescribed area A2 according to a selection operation of the target parking position TP on the HMI 13 by the occupant, and also sets the switching position S of the vehicle 3 in the vicinity of the target parking position TP (step ST27).

Next, the parking controller 45 moves the vehicle 3 to the second determination position DP2 between the first determination position DP1 and the switching position S according to the driving operation on the driving operation member 9 by the occupant (step ST28).

Next, the parking controller 45 executes the second determination process at the second determination position DP2 (step ST29). The contents of the second determination process are the same as those of the example 1 of the vehicle control, and therefore the description thereof will be omitted.

In a case where the parking controller 45 determines that parking at the target parking position TP is prohibited (step ST29: Yes), that is, in a case where the determination result of the second determination process is Yes, the parking controller 45 does not continue the parking assistance control. In this case, the parking controller 45 suspends the parking assistance control before the vehicle 3 reaches the switching position S, and causes the HMI 13 to execute the parking prohibition notification (step ST30). The contents of the parking prohibition notification are the same as those in step ST25, and therefore the description thereof will be omitted.

In a case where the parking controller 45 determines that parking at the target parking position TP is not prohibited (step ST29: No), that is, in a case where the determination result of the second determination process is No, the parking controller 45 continues the parking assistance control. In this case, the parking controller 45 generates (sets) the parking trajectory X that leads from the second determination position DP2 to the target parking position TP via the switching position S (step ST31).

Next, the parking controller 45 moves the vehicle 3 from the second determination position DP2 to the target parking position TP along the parking trajectory X (step ST32).

### Effects

In the above-mentioned examples 1 and 2 of the vehicle control, when the vehicle 3 is at the first determination position DP1 (i.e., before the vehicle 3 approaches the target parking position TP), the parking controller 45 executes the first determination process including the determination as to whether parking in the prescribed area A2 is prohibited, and determines whether to start the parking control (automatic parking control or the parking assistance control) based on the determination result of the first determination process. This reduces the risk of the parking control being suspended after the vehicle 3 approaches the target parking position TP, and reduces the burden on the occupant.

Further, when the vehicle 3 reaches the second determination position DP2 (i.e., when the vehicle 3 approaches the target parking position TP), the parking controller 45 executes the second determination process including the determination as to whether parking at the target parking position TP is prohibited. Accordingly, it is possible to accurately determine whether parking at the target parking position TP is prohibited, and to cause the HMI 13 to execute the parking prohibition notification according to the determination result. This can urge the occupant to comply with traffic rules.

### The Modified Example 1 of the Vehicle Control

In the examples 1 and 2 of the vehicle control, the parking controller 45 determines in the first determination process only whether parking in the prescribed area A2 is prohibited. In the modified example 1 of the vehicle control, the parking controller 45 determines in the first determination process whether parking in the prescribed area A2 is prohibited and whether the parked vehicle PV is present in the prescribed area A2.

Upon determining in the first determination process that parking in the prescribed area A2 is not prohibited and the parked vehicle PV is not present in the prescribed area A2, the parking controller 45 starts the parking control (the automatic parking control or the parking assistance control). In this case, the parking controller 45 moves the vehicle 3 along the parking trajectory X to the target parking position TP without executing the second determination process.

Upon determining in the first determination process that parking in the prescribed area A2 is prohibited and the parked vehicle PV is not present in the prescribed area A2, the parking controller 45 does not start the parking control. In this case, the parking controller 45 terminates the vehicle control without executing the second determination process.

Upon determining in the first determination process that parking in the prescribed area A2 is not prohibited or that the parked vehicle PV is present in the prescribed area A2 while possibility of parking in the prescribed area A2 is unknown, the parking controller 45 starts the parking control. In this case, the parking controller 45 moves the vehicle 3 to the second determination position DP2, and then executes the second determination process.

Upon determining in the first determination process that parking in the prescribed area A2 is prohibited and the parked vehicle PV is present in the prescribed area A2, the parking controller 45 starts the parking control. In this case, the parking controller 45 moves the vehicle 3 to the second determination position DP2, and then executes the second determination process. Even if it is determined in the first determination process that parking in the prescribed area A2 is prohibited, a location within the prescribed area A2 where parking is permitted may be present in a case where the parked vehicle PV is present in the prescribed area A2. Considering such a possibility, as described above, the parking controller 45 may start (or continue) the parking control. Further, the parking controller 45 may notify the occupant that parking in the prescribed area A2 is prohibited and the parked vehicle PV is present in the prescribed area A2, and ask the occupant to judge whether parking is permitted. In another embodiment, upon determining that parking in the prescribed area A2 is prohibited and the parked vehicle PV is present in the prescribed area A2, the parking controller 45 may not start (or continue) the parking control.

In the examples 1 and 2 of the vehicle control, the parking controller 45 determines in the second determination process only whether parking at the target parking position TP is prohibited. In the modified example 1 of the vehicle control, the parking controller 45 determines in the second determination process whether parking at the target parking position TP is prohibited and whether the parked vehicle PV is present at the target parking position TP. The determination method in the second determination process is the same as the determination method in the first determination process, and therefore the description thereof will be omitted.

In the examples 1 and 2 of the vehicle control, the parking controller 45 determines in the first determination process whether parking in the prescribed area A2 is prohibited based only on the presence/absence and color of the curb B1 in the prescribed area A2. In the modified example 1 of the vehicle control, the parking controller 45 determines in the first determination process whether parking in the prescribed area A2 is prohibited based on the presence/absence and color of the curb B1 in the prescribed area A2, the presence/absence and type of the road sign B2 in the prescribed area A2, and the presence/absence and type of the road marking B3 in the prescribed area A2.

For example, in a case where the curb B1 of the prescribed color (for example, a red curb) is present in the prescribed area A2, in a case where the road sign B2 of the prescribed type (for example, a fire hydrant sign or a parking prohibition sign) is present in the prescribed area A2, or in a case where the road marking B3 of the prescribed type (for example, a parking prohibition marking) is present in the prescribed area A2, the parking controller 45 determines that parking in the prescribed area A2 is prohibited. On the other hand, in a case where the curb B1 of the prescribed color is not present in the prescribed area A2, the road sign B2 of the prescribed type is not present in the prescribed area A2, and the road marking B3 of the prescribed type is not present in the prescribed area A2, the parking controller 45 determines that parking in the prescribed area A2 is not prohibited. Upon determining that the road sign B2 of the prescribed type is present in the prescribed area A2 and the parked vehicle PV is present in the prescribed area A2, the parking controller 45 does not start the parking control.

In the examples 1 and 2 of the vehicle control, the parking controller 45 determines in the second determination process whether parking at the target parking position TP is prohibited based only on the presence/absence and color of the curb B1 on the side of the target parking position TP. In the modified example 1 of the vehicle control, the parking controller 45 determines in the second determination process whether parking at the target parking position TP is prohibited based on the presence/absence and color of the curb B1 on the side of the target parking position TP, the presence/absence and type of the road sign B2 on the side of the target parking position TP, and the presence/absence and type of the road marking B3 on the side of the target parking position TP. The determination method in the second determination process is the same as the determination method in the first determination process, and therefore the description thereof will be omitted.

### The Modified Example 2 of the Vehicle Control

In the examples 1 and 2 of the vehicle control, the parking controller 45 determines in the first determination process only whether parking in the prescribed area A2 is prohibited. In the modified example 2 of the vehicle control, the parking controller 45 determines in the first determination process whether parking in the prescribed area A2 is prohibited, whether parking in the prescribed area A2 is restricted, and the type of the parking restriction (user, time, use, and the like) for the prescribed area A2.

For example, in a case where the curb B1 of the first color (for example, a red curb) is present in the prescribed area A2, the parking controller 45 determines that parking in the prescribed area A2 is prohibited. In a case where the curb B1 of the second color (for example, a blue curb) is present in the prescribed area A2, the parking controller 45 determines that parking in the prescribed area A2 is restricted to the prescribed user. In a case where the curb B1 of the third color (for example, a green curb) is present in the prescribed area A2, the parking controller 45 determines that parking in the prescribed area A2 is restricted within the prescribed time. In a case where the curb B1 of the fourth color (for example, a yellow curb) is present in the prescribed area A2, the parking controller 45 determines that parking in the prescribed area A2 is restricted to the prescribed use. In a case where the curb B1 of the fifth color (for example, a white curb) is present in the prescribed area A2, the parking controller 45 determines that parking in the prescribed area A2 is restricted to the prescribed use and the prescribed time. In a case where the curb B1 is not present in the prescribed area A2, or in a case where the curb B1 in the prescribed area A2 is not colored, the parking controller 45 determines that parking in the prescribed area A2 is not prohibited or restricted.

The HMI 13 executes a first notification based on the result of the first determination process. For example, in a case where the parking controller 45 determines in the first determination process that parking in the prescribed area A2 is not prohibited or restricted, the HMI 13 executes the first notification including a message indicating that parking is possible. In a case where the parking controller 45 determines in the first determination process that parking in the prescribed area A2 is prohibited, the HMI 13 executes the first notification including a message indicating that parking is prohibited. In a case where the parking controller 45 determines in the first determination process that parking in the prescribed area A2 is restricted, the HMI 13 executes the first notification including a message indicating the type of the parking restriction for the prescribed area A2.

In the examples 1 and 2 of the vehicle control, the parking controller 45 determines in the second determination process only whether parking at the target parking position TP is prohibited. In the modified example 2 of the vehicle control, the parking controller 45 determines in the second determination process whether parking at the target parking position TP is prohibited, whether parking at the target parking position TP is restricted, and the type of the parking restriction (user, time, use, and the like) for the target parking position TP. The determination method in the second determination process is the same as the determination method in the first determination process, and therefore the description thereof will be omitted.

The result of the second determination process may match the result of the first determination process. For example, the parking controller 45 may determine in the first determination process that parking in the prescribed area A2 is prohibited, and determine in the second determination process that parking at the target parking position TP is prohibited. In such a case, the parking controller 45 does not execute the notification to the occupant based on the result of the second determination process.

The result of the second determination process may not match the result of the first determination process. For example, the parking controller 45 may determine in the first determination process that parking in the prescribed area A2 is not prohibited or restricted, and determine in the second determination process that parking at the target parking position TP is prohibited or restricted. Further, the parking controller 45 may determine in the first determination process that parking in the prescribed area A2 is prohibited, and determine in the second determination process that parking at the target parking position TP is not prohibited or restricted, or determine in the second determination process that parking at the target parking position TP is restricted. Further, the parking controller 45 may determine in the first determination process that parking in the prescribed area A2 is restricted, and determine in the second determination process that parking at the target parking position TP is not prohibited or restricted, or determine in the second determination process that parking at the target parking position TP is prohibited, or determine in the second determination process the type of parking restriction different from the type of parking restriction determined in the first determination process. In these cases, the HMI 13 executes a second notification based on the result of the second determination process. The contents of the second notification are different from the contents of the first notification.

The parking controller 45 may determine in the first determination process that parking in the prescribed area A2 is not restricted and determine in the second determination process that parking at the target parking position TP is restricted. Further, the type of parking restriction for the target parking position TP determined by the parking controller 45 in the second determination process may be different from the type of parking restriction for the prescribed area A2 determined by the parking controller 45 in the first determination process. In these cases, the parking controller 45 determines whether the HMI 13 has received the permission operation of the parking control by the occupant. In a case where the HMI 13 has received the permission operation of the parking control by the occupant, the parking controller 45 continues the parking control and moves the vehicle 3 to the target parking position TP along the parking trajectory X. In a case where the HMI 13 has not received the permission operation of the parking control by the occupant, the parking controller 45 does not continue the parking control and suspends the parking control.

### Other Modified Embodiments

In the examples 1 and 2 of the vehicle control, the parking controller 45 determines in the first determination process only whether parking in the prescribed area A2 is prohibited, and determines in the second determination process only whether parking at the target parking position TP is prohibited. In another modified embodiment, the parking controller 45 may determine in the first determination process only whether parking in the prescribed area A2 is restricted, and may determine in the second determination process only whether parking at the target parking position TP is restricted.

In the examples 1 and 2 of the vehicle control, the parking controller 45 starts the parking control after executing the first determination process. Accordingly, the parking controller 45 determines “whether to start the parking control” based on the result of the first determination process. In another modified embodiment, the parking controller 45 may execute the first determination process after starting the parking control. In this case, the parking controller 45 determines “whether to continue the parking control” based on the result of the first determination process.

In the examples 1 and 2 of the vehicle control, the parking controller 45 executes the second determination process based on the same determination index (i.e., the presence/absence and color of the curb B1) as the first determination process. In another modified embodiment, the parking controller 45 may execute the second determination process based on more determination indexes than the first determination process. For example, the parking controller 45 may execute the first determination process based on the presence/absence and color of the curb B1, and execute the second determination process based on the presence/absence and color of the curb B1, the presence/absence and type of the road sign B2, and the presence/absence and type of the road marking B3.

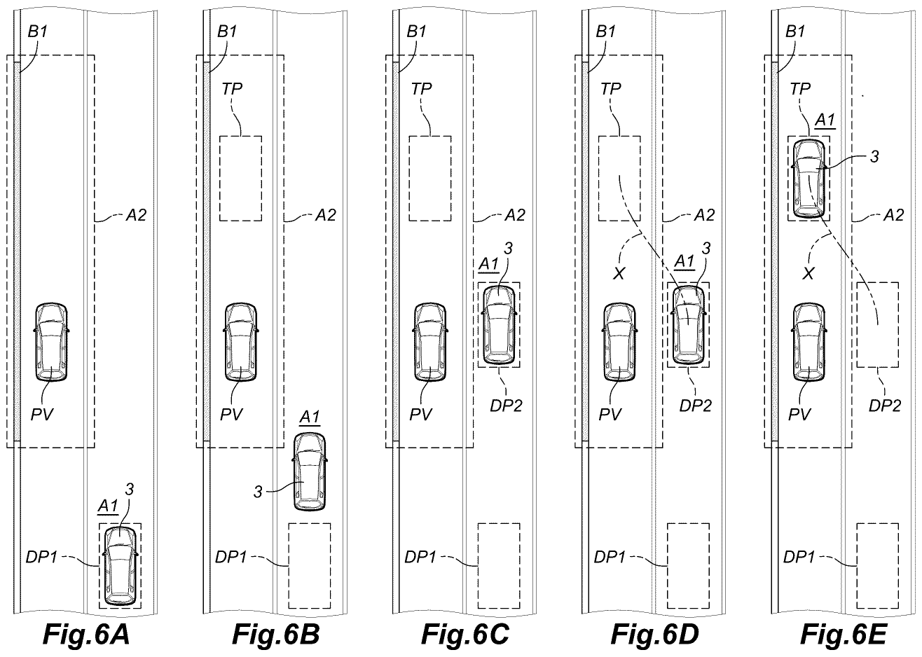

In the examples 1 and 2 of the vehicle control, the parking trajectory X of the vehicle 3 includes the switching position S. In another modified embodiment, as shown in FIGS. 6A to 6E, the parking trajectory X of the vehicle 3 may not include the switching position S.

In the modified example 1 of the vehicle control, upon determining in the first determination process that the parked vehicle PV is present in the prescribed area A2, the parking controller 45 executes the second determination process regardless of whether parking in the prescribed area A2 is prohibited. In another modified embodiment, the parking controller 45 may execute the second determination process only upon determining that parking in the prescribed area A2 is prohibited and the parked vehicle PV is present.

In the modified example 2 of the vehicle control, the HMI 13 executes the first notification regardless of the determination result of the first determination process. In another modified embodiment, the HMI 13 may execute the first notification only in a case where the determination result of the first determination process is a specific result. For example, the HMI 13 may execute the first notification including a message such as “Please check whether you can park in this location.” only in a case where the parking controller 45 determines in the first determination process that parking in the prescribed area A2 is prohibited.

This concludes the description of the specific embodiments, but the present invention is not limited to the above embodiments or modified embodiments, and can be widely modified and implemented.

### Summary of Embodiments

According to one aspect, a vehicle control system 1 comprises: an acquirer 11 configured to acquire information about a surrounding area A1 of a vehicle 3; and a parking controller 45 configured to execute parking control of the vehicle 3 based on an acquisition result of the acquirer 11, wherein the parking controller 45 is configured to: execute a first determination process including determination as to whether parking in a prescribed area A2 within the surrounding area A1 is prohibited or restricted; determine whether to start or continue the parking control based on a result of the first determination process; and execute, upon determining to start or continue the parking control, a second determination process at a position DP2 closer to a target parking position TP within the prescribed area A2 than a position DP1 at which the first determination process is executed, the second determination process including determination as to whether parking at the target parking position TP is prohibited or restricted.

According to this aspect, the parking controller 45 executes the first determination process, which includes the determination as to whether parking in the prescribed area A2 is prohibited or restricted, at an earlier stage (before the vehicle 3 approaches the target parking position TP), and determines whether to start or continue the parking control based on the result of the first determination process. This reduces the risk of the parking control being suspended after the vehicle 3 approaches the target parking position TP, and reduces the burden on the occupant. Further, the parking controller 45 executes the second determination process, which includes the determination as to whether parking at the target parking position TP is prohibited or restricted, at the position DP2 closer to the target parking position TP within the prescribed area A2 than the position DP1 at which the first determination process is executed. Accordingly, it is possible to accurately determine whether parking at the target parking position TP is prohibited or restricted and to execute the notification to the occupant based on the determination result. This can urge the occupant to comply with traffic rules.

Preferably, the vehicle control system 1 further comprises a notifier 13 configured to execute a notification to an occupant of the vehicle 3, wherein the notifier 13 is configured to: execute a first notification based on the result of the first determination process; and execute a second notification in a case where a result of the second determination process does not match the result of the first determination process, a content of the second notification being different from a content of the first notification.

According to this aspect, in a case where the result of the second determination process does not match the result of the first determination process, it is possible to properly notify the occupant of the result of the second determination process.

Preferably, the vehicle control system 1 further comprises an operation unit 13 configured to receive an operation by an occupant of the vehicle 3, wherein the parking controller 45 is configured to determine whether to continue the parking control based on the operation on the operation unit 13 upon determining in the first determination process that parking in the prescribed area A2 is not restricted and determining in the second determination process that parking at the target parking position TP is restricted.

According to this aspect, in a case where the parking purpose of the occupant matches the parking restriction determined in the second determination process, it is possible to continue the parking control according to the intention of the occupant.

Preferably, the vehicle control system 1 further comprises an operation unit 13 configured to receive an operation by an occupant of the vehicle 3, wherein the parking controller 45 is configured to: determine a type of parking restriction for the prescribed area A2 in the first determination process; determine a type of parking restriction for the target parking position TP in the second determination process; and determine whether to continue the parking control based on the operation on the operation unit 13 in a case where the type of the parking restriction for the target parking position TP determined in the second determination process is different from the type of the parking restriction for the prescribed area A2 determined in the first determination process.

According to this aspect, in a case where the parking purpose of the occupant matches the type of the parking restriction determined in the second determination process, it is possible to continue the parking control according to the intention of the occupant.

Preferably, the parking controller 45 is configured to determine not to start or continue the parking control upon determining in the first determination process that parking in the prescribed area A2 is prohibited.

According to this aspect, upon determining in the first determination process that parking in the prescribed area A2 is prohibited, the parking controller 45 can cancel the start of the parking control early or suspend the parking control early.

Preferably, the vehicle control system 1 further comprises an operation unit 13 configured to receive an operation by an occupant of the vehicle 3, wherein the parking controller 45 is configured to determine whether to start or continue the parking control based on the operation on the operation unit 13 upon determining in the first determination process that parking in the prescribed area A2 is prohibited or restricted.

According to this aspect, even in a case where the parking controller 45 determines in the first determination process that parking in the prescribed area A2 is prohibited or restricted, it is possible to start or continue the parking control according to the intention of the occupant. Accordingly, it is possible to execute the parking control that matches the intention of the occupant.

Preferably, a parking trajectory X of the vehicle 3 includes a switching position S of the vehicle 3, and the parking controller 45 is configured to: execute the second determination process before the vehicle 3 reaches the switching position S; and suspend the parking control before the vehicle 3 reaches the switching position S upon determining in the second determination process that parking at the target parking position TP is prohibited.

According to this aspect, in a case where parking at the target parking position TP is prohibited, it is possible to suspend the parking control at an earlier stage (i.e., before the vehicle 3 reaches the switching position S). This further reduces the burden on the occupant.

Preferably, the parking controller 45 is configured to execute the first determination process and the second determination process based on a road structure present in the prescribed area A2.

According to this aspect, it is possible to properly determine whether parking in the prescribed area A2 or at the target parking position TP is prohibited or restricted.

Preferably, the parking controller 45 is configured to execute the first determination process based on whether a parked vehicle PV is present in the prescribed area A2.

According to this aspect, it is possible to further properly determine whether parking in the prescribed area A2 or at the target parking position TP is prohibited or restricted.

Preferably, the parking controller 45 is configured to determine to start or continue the parking control and execute the second determination process upon determining in the first determination process that the parked vehicle PV is present in the prescribed area A2.

According to this aspect, at a proper timing, it is possible to execute the second determination process and to determine whether parking at the target parking position TP is prohibited or restricted.

Preferably, the parking controller 45 is configured to: determine to start or continue the parking control and move the vehicle 3 to the target parking position TP without executing the second determination process upon determining in the first determination process that parking in the prescribed area A2 is not prohibited and the parked vehicle PV is not present in the prescribed area A2; and determine not to start or continue the parking control upon determining in the first determination process that parking in the prescribed area A2 is prohibited and the parked vehicle PV is not present in the prescribed area A2.

According to this aspect, in a case where the first determination process makes it obvious that parking in the prescribed area A2 is possible or impossible, the second determination process is omitted, so that the time required for the parking control is shortened. This further reduces the burden on the occupant.

1. A vehicle control system, comprising:
an acquirer configured to acquire information about a surrounding area of a vehicle; and
a parking controller configured to execute parking control of the vehicle based on an acquisition result of the acquirer,
wherein the parking controller is configured to:
execute a first determination process including determination as to whether parking in a prescribed area within the surrounding area is prohibited or restricted;
determine whether to start or continue the parking control based on a result of the first determination process; and
execute, upon determining to start or continue the parking control, a second determination process at a position closer to a target parking position within the prescribed area than a position at which the first determination process is executed, the second determination process including determination as to whether parking at the target parking position is prohibited or restricted.

2. The vehicle control system according to claim 1, further comprising a notifier configured to execute a notification to an occupant of the vehicle,
wherein the notifier is configured to:
execute a first notification based on the result of the first determination process; and
execute a second notification in a case where a result of the second determination process does not match the result of the first determination process, a content of the second notification being different from a content of the first notification.

3. The vehicle control system according to claim 1, further comprising an operation unit configured to receive an operation by an occupant of the vehicle,
wherein the parking controller is configured to determine whether to continue the parking control based on the operation on the operation unit upon determining in the first determination process that parking in the prescribed area is not restricted and determining in the second determination process that parking at the target parking position is restricted.

4. The vehicle control system according to claim 1, further comprising an operation unit configured to receive an operation by an occupant of the vehicle,
wherein the parking controller is configured to:
determine a type of parking restriction for the prescribed area in the first determination process;
determine a type of parking restriction for the target parking position in the second determination process; and
determine whether to continue the parking control based on the operation on the operation unit in a case where the type of the parking restriction for the target parking position determined in the second determination process is different from the type of the parking restriction for the prescribed area determined in the first determination process.

5. The vehicle control system according to claim 1, wherein the parking controller is configured to determine not to start or continue the parking control upon determining in the first determination process that parking in the prescribed area is prohibited.

6. The vehicle control system according to claim 1, further comprising an operation unit configured to receive an operation by an occupant of the vehicle,
wherein the parking controller is configured to determine whether to start or continue the parking control based on the operation on the operation unit upon determining in the first determination process that parking in the prescribed area is prohibited or restricted.

7. The vehicle control system according to claim 1, wherein a parking trajectory of the vehicle includes a switching position of the vehicle, and
the parking controller is configured to:
execute the second determination process before the vehicle reaches the switching position; and
suspend the parking control before the vehicle reaches the switching position upon determining in the second determination process that parking at the target parking position is prohibited.

8. The vehicle control system according to claim 1, wherein the parking controller is configured to execute the first determination process and the second determination process based on a road structure present in the prescribed area.

9. The vehicle control system according to claim 8, wherein the parking controller is configured to execute the first determination process based on whether a parked vehicle is present in the prescribed area.

10. The vehicle control system according to claim 9, wherein the parking controller is configured to determine to start or continue the parking control and execute the second determination process upon determining in the first determination process that the parked vehicle is present in the prescribed area.

11. The vehicle control system according to claim 10, wherein the parking controller is configured to:
determine to start or continue the parking control and move the vehicle to the target parking position without executing the second determination process upon determining in the first determination process that parking in the prescribed area is not prohibited and the parked vehicle is not present in the prescribed area; and
determine not to start or continue the parking control upon determining in the first determination process that parking in the prescribed area is prohibited and the parked vehicle is not present in the prescribed area.
